(19) United States
(12) Patent Application Publication
(10) Pub. No.: US 2017/0159402 A1
(43) Pub. Date: Jun. 8, 2017

(54) METHOD OF ENHANCING CIRCULATION DURING DRILL-OUT OF A WELLBORE BARRIER USING DISSOVABLE SOLID PARTICULATES

(71) Applicant: BAKER HUGHES INCORPORATED, Houston, TX (US)

(72) Inventors: Scott G. Nelson, Cypress, TX (US); Jimie DeVon Lemons, Houston, TX (US); D.V. Satyanarayana Gupta, The Woodlands, TX (US); Harold Dean Brannon, Magnolia, TX (US); Anna Jensen, The Woodlands, TX (US); Benjamin Tatum, Oklahoma City, OK (US); Alexander Pirogov, Tomball, TX (US)

(21) Appl. No.: 14/957,589

(22) Filed: Dec. 2, 2015

(51) Int. Cl. E21B 33/13; C09K 8/42; E21B 37/00

(52) U.S. Cl. CPC E21B 33/13; E21B 37/00; C09K 8/426; E21B 43/14

(57) ABSTRACT

A fluid-impermeable barrier, used to isolate stimulated intervals in a reservoir during a multi-zone fracturing operation, may be removed from the wellbore which penetrates the reservoir using a circulating fluid containing dissolvable solid particulates. The dissolvable solid particulates bridge perforation clusters during clean-out of the wellbore and thus inhibit passage of the circulating fluid into the fracture network through the perforation clusters.

### FIELD OF THE DISCLOSURE

The disclosure relates to a method of enhancing circulation during drill-out of a barrier in a wellbore using a fluid comprising dissolvable solid particulates.

### BACKGROUND OF THE DISCLOSURE

Hydrocarbons are often recovered from a subterranean reservoir by stimulation treatments, such as hydraulic fracturing. Typically, a subterranean reservoir penetrated by a horizontal wellbore has an extensive length contacting a single, or a plurality of distinct zones or formations of interest. In such instances, hydraulic fracturing consists of stimulating the reservoir in multiple pumping stages or sequences. Such multi-zone stimulation is especially used in the treatment of low permeability reservoirs, such as shale.

A common method of multi-stage fracturing is known as “plug and perf” wherein, after the formation of perforation clusters, a first zone (farthest from the surface) is stimulated. After stimulation, a barrier is placed into the wellbore thereby sealing the first zone from the next zone to be perforated. This sequence of steps is repeated until all of the zones targeted to be stimulated have been completed.

After stimulation has been completed for all of the targeted zones and prior to production, each barrier is drilled out of or otherwise removed from the well using a circulating fluid. In drill-out, the barrier is first milled leaving behind debris, such as rubber and metal. The area is cleaned by circulating water or brine into the zone. In a multi-zone stimulation operation, the barrier closest to the surface is removed first and the barrier farthest from the surface is removed last. In a horizontal well, for example, the barrier closest to the heel is drilled-out first and the barrier in the toe is drilled-out last. Drill-out operations can be conducted with coiled tubing or jointed pipe and a surface rig. When drill-out is completed, production tubing is then installed into the wellbore.

While the objective of drill-out is for the circulating fluid to be circulated back into the annulus and then onto the surface with the debris, well operators often experience leakage of the circulating fluid into stimulated fractures. As more and more zones are subjected to drill-out, the loss of circulating fluid into more and more connecting fractures increases. The loss of the circulating fluid into the stimulated fractures causes a loss of fluid circulation to the surface.

There is a need therefore for a method which enhances the return of circulating fluid with debris through the annulus and recovery of the debris at the surface.

It should be understood that the above-described discussion is provided for illustrative purposes only, may or may not constitute prior art and is not intended to limit the scope or subject matter of the appended claims or those of any related patent application or patent. Thus, none of the appended claims or claims of any related application or patent should be limited by the above discussion or construed to address, include or exclude each or any of the above-cited features or disadvantages merely because of the mention thereof.

### SUMMARY OF THE DISCLOSURE

The disclosure relates to a method of enhancing the efficiency in removal of debris from a wellbore penetrating a multi-zoned subterranean reservoir. The debris originates, at least in part, from a fluid-impermeable barrier which separates perforated zones during a multi-zone fracturing operation. In the method, the fluid-impermeable barrier is first milled separating the perforated zone. A circulating fluid is then introduced into the wellbore which proceeds into the separated perforated zones. The circulating fluid comprises water or brine and dissolvable solid particulates. Perforation clusters are plugged in the separated perforated zones with the dissolvable solid particulates. This prevents the flow of the circulating fluid through the perforation clusters. Debris is then removed from the wellbore in the circulating fluid.

The disclosure also relates to a method of drilling out a barrier from a wellbore after stimulating multiple zones through perforation clusters. The barrier separates perforation clusters in a first zone from a second zone. In the method, the barrier isolating the first zone from the second zone is first milled. Circulating fluid comprising dissolvable solid particulates is then pumped the wellbore. The flow of circulating fluid into fractures in the first zone and the second zone through the perforation clusters is at least partially blocked with the dissolvable solid particulates. Debris may then be removed from the wellbore in the circulating fluid.

In another embodiment, a method of cleaning out a wellbore penetrating a subterranean reservoir is provided. Prior to clean out, different zones of the subterranean reservoir have been successively stimulated by flowing fracturing fluid through perforation clusters. Clean out is necessitated by contamination of the wellbore with debris which may include that originating from a barrier separating two adjacent stimulated zones. In the method, the barrier isolating the two adjacent zones is drilled out. Fluid comprising dissolvable solid particulates is then circulated into the two adjacent zones. The flow of circulating fluid is, at least partially, blocked from entering into the fractures through the perforation clusters by bridging or plugging the perforation clusters with the dissolvable solid particulates. Debris is then removed from the wellbore in the circulating fluid.

In another embodiment, a method of enhancing the efficiency in production of hydrocarbons from a wellbore penetrating a subterranean reservoir is provided. In this method, a fracturing fluid is pumped through perforated clusters in the wellbore into a first (or penultimate) productive zone in the subterranean reservoir. The first or penultimate isolated productive zone is isolated from a second (or successive) productive zone by inserting a fluid-impermeable barrier into the wellbore. A fracturing fluid is then pumped through the perforated clusters in the wellbore into the second or successive productive zone in the subterranean reservoir. The barrier is then removed, creating a flow path from the penultimate productive zone into the successive productive zone. Fluid is circulated in the wellbore. The circulating fluid comprises dissolvable solid particulates. The flow of circulating fluid through the perforation clusters into fractures is, at least partially, blocked by the dissolvable solid particulates. Circulating fluid with debris is then removed from the wellbore.

In an embodiment, the circulating fluid may further contain a proppant.

In an embodiment, the dissolvable solid particulates may be selected from aliphatic polyesters, benzoic acid, phthalic acid, phthalic anhydride, terephthalic anhydride, terephthalic acid, gilsonite, rock salt, benzoic acid flakes, polylactic acid as well as a combination thereof

In an embodiment, the dissolvable solid particulates may be of the formula:

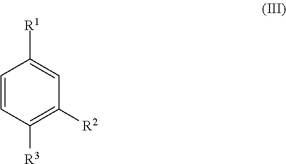

or anhydrides therefore, wherein:
R¹ is —COO—(R⁵O)_{y}—R⁴ or —H;
R² and R³ are selected from the group consisting of —H and —COO—(R⁵O)_{y}—R⁴;
   provided both R² or R³ are —COO—(R⁵O)_{y}—R⁴ when R¹ is —H and
   further provided only one of R² or R³ is —COO—(R⁵O)_{y}—R⁴ when R¹ is —COO—(R⁵O)_{y}—R⁴;
R⁴ is —H or a C₁-C₆ alkyl group;
R⁵ is a C₁-C₆ alkylene group; and
each y is 0 to 5.

Characteristics and advantages of the present disclosure described above and additional features and benefits will be readily apparent to those skilled in the art upon consideration of the following detailed description of various embodiments and referring to the accompanying drawing.

### DETAILED DESCRIPTION OF THE PREFERRED EMBODIMENTS

Characteristics and advantages of the present disclosure and additional features and benefits will be readily apparent to those skilled in the art upon consideration of the following detailed description of exemplary embodiments. It should be understood that the description herein, being of example embodiments, are not intended to limit the claims of this patent or any patent or patent application claiming priority hereto. Many changes may be made to the particular embodiments and details disclosed herein without departing from such spirit and scope.

As used herein and throughout various portions (and headings) of this patent application, the terms “disclosure”, “present disclosure” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. Also, the terms “including” and “comprising” are used herein and in the appended claims in an open-ended fashion, and thus should be interpreted to mean “including, but not limited to . . . .”

The circulating fluid disclosed herein may be used to drill out or remove barriers and/or proppants left behind in the wellbore following a hydraulic fracturing treatment. (The term “barrier” shall include both plugs and balls, as discussed herein.) Typically, the barrier may be composed of non-biodegradable materials which may include rubber, nylon, metal, synthetic and non-synthetic composites including carbon composites, etc.

As such, the disclosure provides a method of cleaning debris from a wellbore after stimulating the subterranean reservoir penetrated by the wellbore but before production of hydrocarbons from the reservoir.

In an embodiment, clean out, following the removal of one or more fluid-impermeable barriers used in multi-zone stimulation operations, is enhanced by introducing into the wellbore a circulating fluid which contains dissolvable solid particulates. The presence of the dissolvable solid particulates in the circulating fluid enhances the removal of debris from the wellbore. Production of hydrocarbons from the wellbore is further enhanced since the dissolvable solid particulates prevent the loss of the circulating fluid (having debris) into fractures within the fracture network created during stimulation.

The wellbore subjected to the method disclosed herein may an oil producing, gas producing or water producing well or may be a geothermal well.

The well may be a horizontal well as well as a vertical well. A horizontal well, as used herein, refers to any deviated well. These wells can include, for example, any well which deviates from a true vertical axis more than 60 degrees.

The wellbore to which the circulating fluid is introduced penetrates a subterranean reservoir. The subterranean reservoir is subjected to multiple stage fracturing. As used herein, the term “subterranean reservoir” shall include carbonate formations, such as limestone, chalk or dolomite as well as subterranean sandstone, coal or siliceous formations in oil and gas wells, including quartz, clay, shale, silt, chert, zeolite or a combination thereof. The term shall also refer to coal beds having a series of natural fractures, or cleats used in the recovery of natural gases, such as methane, and/or sequestering a fluid which is more strongly adsorbing than methane, such as carbon dioxide and/or hydrogen sulfide.

Multiple stage fracturing, also known as multi-zone fracturing, proceeds by first dividing the areas to be stimulated into discrete intervals. One interval is stimulated followed by a second. It is not uncommon for more than 30 intervals to be stimulated in a fracturing operation. Prior to proceeding to stimulate a second interval, a barrier is put into the wellbore to isolate the stimulated fracture from the second zone and to ensure that fracturing fluid pumped into the well is directed to the zone of interest.

In a multi-zone fracturing operation, the first zone subjected to stimulation is the farthest from the ground or platform surface. For instance, in a vertical well, the second zone is uphole from the first zone. In a horizontal wellbore, the first zone is closest to the toe while the second zone is closer to the heel.

A well known method of stimulation is commonly known as “plug and perf”. Plug and perf is the preferred method of stimulating horizontal wells. In this method, a production liner or a casing is first installed in the wellbore. A cementitious slurry is then pumped into the well and circulated down the inside of a production liner, casing or pipe and back up the outside of the liner, casing or pipe through the annular space between the exterior of the production liner, casing or pipe and the wellbore. After the cementitious slurry is set and hardened as a sheath, one or more perforating guns are conveyed on a wireline (typically in vertical wells) or coiled tubing (typically in horizontal wells) into the well and the gun(s) is positioned adjacent to the formation and then selectively fired to perforate the zone. The production lining or casing of the first zone is perforated with a perforating gun which renders a multitude of perforation clusters extending through the walls of the liner and/or casing and through the cement sheath surrounding the casing or liner. The perforating gun is then removed from the wellbore and fracturing fluid is then pumped into the wellbore through the perforation clusters and into the first zone of the subterranean reservoir fractures are initiated or extended in the first zone. Where proppant is present in the fracturing fluid, the proppant enters the fractures and holds the fractures open.

In place of forming perforation clusters with a perforating gun, in some cases a casing or a production liner may have pre-existing ports. Such pre-existing ports shall be regarded the same as perforation clusters herein.

Following stimulation, a fluid-impermeable first barrier is placed into the wellbore and seals off the first zone from the second zone. The term “fluid-impermeable barrier”, as used herein, shall refer to a barrier which isolates, substantially impairs or prevents the flow of fluids to a previously stimulated interval. Wirelines are typically used to run the barrier into a vertical well. With horizontal wellbores, coiled tubing is preferably used in order to push and set the barrier into the wellbore.

Perforation clusters are then made in the production liner in the second zone. Fracturing fluid is pumped into the second zone and fractures are initiated or extended in the second zone. After the second zone is fractured, a second fluid-impermeable barrier is introduced into the wellbore to seal off the second zone from a third zone. Perforation clusters are then made in the third zone and fracturing fluid is then pumped into the third zone to create or enhance fractures in the third zone. After the third zone is fractured, a third fluid-impermeable barrier is introduced into the wellbore to seal off the third zone from a fourth zone. Perforation cloisters are then made in the fourth zone and fracturing fluid is then pumped into the fourth zone to create or enhance fractures in the fourth zone. The process is repeated for the number of zones which are pre-determined to be stimulated in the reservoir.

In order to begin the flowback of the fracturing fluids through the production liner, casing or pipe, the barriers must be first drilled out. Drill-out is typically performed by a coiled tubing unit (having a positive displacement motor and a mill/bit run) or a jointed pipe. With horizontal wells, a coiled tubing is more typically used. During drill-out, circulating fluid containing the dissolvable solid particulates is introduced into the wellbore at the end of the tubing or pipe and returns up into the annulus. The dissolvable solid particulates bridge or block the perforation clusters by sealing against the hydraulic fractures created during the stimulation process, such that the circulating fluid (with the debris) is unable to leak into the reservoir through the perforation clusters and the fracture network created during stimulation.

The efficiency of the drill-out operation is enhanced by the presence of the dissolvable solid particulates in the circulating fluid since the fluid is unable to escape into the fracture network. The circulating fluid with the debris is thus displaced up the annulus between the casing and the borehole and is collected at the surface. Over time, typically before production or right after the start of production, the solid particulates dissolve and the perforation clusters re-open. Produced oil, gas or water may then flow into the wellbore.

Drill-out is typically conducted at temperatures between from about 100° F. to about 300° F. The circulating fluid containing the debris is continuously removed during drill-out as fresh fluid is introduced. The dissolvable nature of the solid particulates further mitigates any damaging effects to surface or sub-surface production systems such as electric submersible pumps, flow lines, separators, etc.

Each of the barriers placed in the wellbore during stimulation is removed in succession in the reverse order from which they were introduced. Thus, in a horizontal wellbore, the fluid-impermeable barrier nearest the heel is removed prior to removal of the fluid-impermeable barrier nearest the toe. In a vertical wellbore, the fluid-impermeable barrier uphole is removed prior to removal of a downhole barrier.

Using the example provided above, the third fluid-impermeable barrier is first removed or broken apart by a mechanical method, such as milling. This establishes a flow path between the fourth and third zones. Following the removal of the barrier, there may be a substantial amount of debris in the flow path. Such debris may clog perforation clusters within the zones. Thus, during removal of the third barrier or shortly thereafter, circulating fluid is introduced into the wellbore to remove debris within the third and fourth zones. The circulating fluid cools the coiled tubing unit or the jointed pipe and allows for the removal of debris from the wellbore. Much of the debris may originate during the removal or breaking apart of the third barrier and may constitute pieces of the drilled barrier. The dissolvable solid particulates in the circulating fluid temporarily bridge, plug or block perforation clusters in the fourth and third zones such that fluid containing the debris is unable to flow into the fractures. (The terms “block” and “plug” when used to denote the action of the dissolvable solid particulates shall be included within the term “bridge” as used herein.)

After or during removal of the circulating fluid (carrying the debris) from the wellbore, the second fluid-impermeable barrier is removed or broken apart and a flow path between the third zone and the second zone is established. Circulating fluid containing the dissolvable solid particulates then flows into the third and second zones and debris is removed from the third and second zones and may continue to be removed from the fourth zone. The passage of the circulating fluid through the perforation clusters in the third zone and second zone may then be blocked by the dissolvable solid particulates.

The process is repeated and the first impermeable barrier isolating the second zone from the first zone is then removed or broken apart and a flow path is established between the second and first zones. The passage of circulating fluid containing debris into the first zone (as well as the second, third and fourth zones) may then be blocked by the dissolvable solid particulates.

While the above paragraphs illustrate stimulation of a four zoned reservoir, one versed in the art will recognize that the procedure may be repeated numerous times until all of the zones targeted for stimulation are completed. In some cases, over 100 zones may be stimulated. To more clearly define such multiple stages, the terms “successive zone” and “penultimate zone” will be used wherein the “successive zone” and the “penultimate zone” refer to the latter and next to latter zones, respectively. For example, where nine intervals are to be stimulated, the ninth zone may be referred to as the “successive stage” and the eighth zone as the “penultimate stage.” Where fifteen zones are stimulated, the fifteenth zone may be referred to as the “successive stage” and the fourteenth zone may be referred to as the “penultimate stage,” etc. Between any penultimate zone and successive zone, a barrier may be inserted after stimulation of the penultimate zone and prior to stimulation of the successive zone.

In an alternative embodiment to the plug and perf method in vertical wells, stimulation may proceed using a frac valve. A frac valve may comprise a housing in the production liner or casing. The housing may have pre-existing ports and a sliding sleeve which may be actuated to open the pre-existing ports. Once opened, fluids are able to flow through the ports and fracture a reservoir in the vicinity of the valve. The sliding sleeves in such valves typically are actuated by dropping a ball onto a ball seat (i.e., a barrier as defined) which is connected to the sleeve. Fracturing proceeds by increasing fluid pressure in the production liner. The increasing pressure actuates the sleeve in the bottom valve, opening the ports and allowing fluid to flow into the first zone. Once the first zone is fractured, a ball is dropped into the well and allowed to settle on the ball seat of the ball-drop valve immediately uphole of the first zone. The seated ball isolates the lower portion of the production liner and prevents the flow of additional frac fluid into the first zone. Continued pumping then shifts the seat downward, along with the sliding sleeve, opening the ports and allowing fluid to flow into the second fracture zone. The process then is repeated with each ball-drop valve uphole until all zones in the reservoir are fractured. Typically, the ball seats downhole are smaller than ball seats uphole.

While seated balls can effectively isolate downhole valves during a multi-stage fracturing operation, once fracturing of the wellbore has been completed the ball seats may present significant restrictions in the production liner which may reduce the subsequent flow of hydrocarbons up the liner. This is especially true when the liner has a large number of ball-drop valves. Thus, it typically is necessary to drill out the liner to remove the seats prior to production.

Drill-out of ball seats prior to production proceeds in the same fashion as in plug and perf stimulation operations. Drill-out is typically performed using a jointed pipe. Each of the barriers placed in the wellbore during stimulation is removed in succession in the reverse order from which they were introduced. Thus, since the method is more typically used with vertical wellbores, a ball seat uphole is removed prior to removal of a downhole ball seat.

Circulating fluid containing the dissolvable solid particulates is introduced into the wellbore at the end of the pipe and returns up into the annulus. The dissolvable solid particulates bridge or block the openings in the downhole valve by sealing against the hydraulic fractures created during the stimulation process, such that the circulating fluid (with the debris) is unable to leak into the reservoir through the valve and the fracture network created during stimulation. Further, the dissolvable solid particulates in the circulating fluid may bridge into lost circulation areas adjacent to the annulus. As such, they may prevent fluid loss and restore fluid circulation in the event of fluid loss. The method to restore circulation within the wellbore is temporary so that post stimulation production potential is maintained.

In a perf and plug stimulation operation, the size distribution of the dissolvable solid particulates should be sufficient or directly proportional to the perforation diameter of the perforation clusters and to the propped fracture beyond the perforation clusters in order to block the loss of circulation fluid into the perforation clusters. When it is necessary to remove ball seats following stimulation, the size distribution of the dissolvable solid particulates should be sufficient to block flow of the circulation fluid through open valves. Since little to no invasion of the debris passes through the perforation clusters or valves and into the reservoir, the debris may be removed from the surface.

The particulates defining the mixture or use in the method disclosed herein have a sized particle distribution effective to block the penetration of debris within the circulating fluid from escaping through the perforation clusters into the fracture network. Typically, the particle size distribution of the particulates is in the range from about 0.1 micron to about 1.0 millimeter. Typically, the dissolvable solid particulates have a particle size between from about 150 μm to about 2000 μm.

Suitable dissolvable solid particulates include phthalic anhydride, terephthalic anhydride, phthalic acid, terephthalic acid, gilsonite, rock salt, benzoic acid flakes, polylactic acid and mixtures thereof.

Other suitable dissolvable solid particulates include unimodal or multimodal polymeric mixtures of ethylene or other suitable, linear or linear, branched alkene plastics, such as isoprene, propylene, and the like. Such polymeric mixtures may include those set forth in U.S. Pat. No. 7,647,964, herein incorporated by reference.

Such ethylene polymeric mixtures typically comprise ethylene and one or more co-monomers selected from the group consisting of alpha-olefins having up to 12 carbon atoms, which in the case of ethylene polymeric mixtures means that the co-monomer or co-monomers are chosen from alpha-olefins having from 3 to 12 carbon atoms (i.e., C₃-C₁₂), including those alpha-olefins having 3 carbon atoms, 4 carbon atoms, 5 carbon atoms, 6 carbon atoms, 7 carbon atoms, 8 carbon atoms, 9 carbon atoms, 10 carbon atoms, 11, carbon atoms, or 12 carbon atoms. Alpha-olefins suitable for use as co-monomers with ethylene in accordance with the present invention can be substituted or un-substituted linear, cyclic or branched alpha.-olefins. Preferred co-monomers suitable for use with the present invention include but are not limited to 1-propene, 1-butene, 4-methyl-1-pentene, 1-pentene, 1-hexene, 1-octene, 1-decene, 1-dodecene, and styrene.

Typical ethylene polymeric mixtures include ethylene-octene polymeric mixtures (including substantially linear elastic olefin polymers), ethylene-butene mixtures, ethylene-styrene mixtures and ethylene-pentene mixtures.

The ethylene-α-olefin polymers useful herein may include linear copolymers, branched copolymers, block copolymers, A-B-A triblock copolymers, A-B diblock copolymers, A-B-A-B-A-B multiblock copolymers, and radial block copolymers, and grafted versions thereof, as well as homopolymers, copolymers, and terpolymers of ethylene and one or more alpha-olefins. Examples of useful compatible polymers include block copolymers having the general configuration A-B-A, having styrene endblocks and ethylene-butadiene or ethylene-butene midblocks, linear styrene-isoprene-styrene polymers, radial styrene-butadiene-styrene polymers and linear styrene-butadiene-styrene polymers.

Other polymers and copolymers include those composed of collagen.

Preferred dissolvable solid particulates for use in the disclosure include those of structural formula (III):

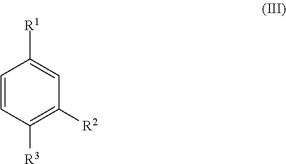

wherein:
R¹ is —COO—(R⁵O)_{y}—R⁴ or —H;
R² and R³ are selected from the group consisting of —H and —COO—(R⁵O)_{y}—R⁴,
   provided both R² or R³ are —COO—(R⁵O)_{y}—R⁴ when R¹ is —H and
   further provided only one of R² or R³ is —COO—(R⁵O)_{y}—R⁴ when R¹ is —COO—(R⁵O)_{y}—R⁴;
R⁴ is —H or a C₁-C₆ alkyl group;
R⁵ is a C₁-C₆ alkylene group; and
each y is 0 to 5.
   Alternatively, the particulates may be an anhydride of the compound of structural formula (III).

In a preferred embodiment, R² of the compound of formula (III) is —H and R³ is —COO—(R⁵O)_{y}—R⁴. In an especially preferred embodiment, the compound of formula (III) is phthalic acid (wherein y is 0 and R¹ and R⁴ are —H). In another preferred embodiment, the compound of formula (III) is phthalic acid anhydride.

Still in another preferred embodiment, R² of the compound of formula (III) is —COO—(R⁵O)_{y}—R⁴ and R³ is —H. In an especially preferred embodiment, the compound of formula (III) is terephthalic acid (wherein y is 0 and R² and R⁴ are —H). In another preferred embodiment, the compound of formula (III) is terephthalic acid anhydride.

Other dissolvable solid particulates include those aliphatic polyesters having the general formula of repeating units illustrated in structural formula (I) below:

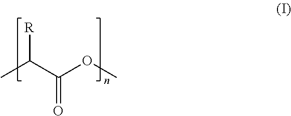

where n is an integer between 75 and 10,000 and R is selected from the group consisting of hydrogen, alkyl (preferably a C₁-C₆ alkyl), aryl (preferably a C₆-C₁₈ aryl), alkylaryl (preferably having from about 7 to about 24 carbon atoms), acetyl, heteroatoms (such as oxygen and sulfur) and mixtures thereof. In a preferred embodiment, the weight average molecular weight of the aliphatic polyester is between from about 100,000 to about 200,000.

The weight ratio of particulates of formula (I) and particulates of formula (III) introduced into the wellbore may be between from about 95:5 to about 5:95 and more typically between from about 40:60 to about 60:40.

A preferred aliphatic polyester is poly(lactide). Poly(lactide) is synthesized either from lactic acid by a condensation reaction or more commonly by ring-opening polymerization of cyclic lactide monomer. Since both lactic acid and lactide can achieve the same repeating unit, the general term poly(lactic acid) as used herein refers to formula (I) without any limitation as to how the polymer was made such as from lactides, lactic acid, or oligomers, and without reference to the degree of polymerization.

The lactide monomer exists generally in three different forms: two stereoisomers L- and D-lactide and racemic D,L-lactide (meso-lactide). The oligomers of lactic acid, and oligomers of lactide may be defined by the formula:

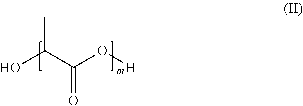

where m is an integer: 2≦m≦75. Preferably m is an integer: 2≦m≦10. These limits correspond to number average molecular weights below about 5,400 and below about 720, respectively. The chirality of the lactide units provides a means to adjust, inter alia, degradation rates, as well as physical and mechanical properties. Poly(L-lactide), for instance, is a semi-crystalline polymer with a relatively slow hydrolysis rate. Poly(D,L-lactide) may be a more amorphous polymer with a resultant faster hydrolysis rate. The stereoisomers of lactic acid may be used individually or combined. Additionally, they may be copolymerized with, for example, glycolide or other monomers like 8-caprolactone, 1,5-dioxepan-2-one, trimethylene carbonate, or other suitable monomers to obtain polymers with different properties or degradation times. Additionally, the lactic acid stereoisomers may be modified by blending high and low molecular weight polylactide or by blending polylactide with other polyesters.

As an alternative to the aliphatic polyesters of formula (I), the phthalic acid or phthalic acid anhydride of formula (III) may be used to enhance the activity of other aliphatic polyesters including star- and hyper-branched aliphatic polyesters polymers as well as other homopolymers, random, block and graft copolymers. Such suitable polymers may be prepared by polycondensation reactions, ring-opening polymerizations, free radical polymerizations, anionic polymerizations, carbocationic polymerizations, and coordinative ring-opening polymerization for, e.g., lactones, and any other suitable process. Specific examples of suitable polymers include polysaccharides such as dextran or cellulose; chitin; chitosan; proteins; orthoesters; poly(glycolide); poly(c-caprolactone); poly(hydroxybutyrate); poly(anhydrides); aliphatic polycarbonates; poly(orthoesters); poly(amino acids); poly(ethylene oxide); and polyphosphazenes.

The circulating fluid is typically water, brine or oil. Suitable brines including those containing potassium chloride, sodium chloride, cesium chloride, ammonium chloride, calcium chloride, magnesium chloride, sodium bromide, potassium bromide, cesium bromide, calcium bromide, zinc bromide, sodium formate, potassium formate, cesium formate, sodium acetate, and mixtures thereof The percentage of salt in the water preferably ranges from about 0% to about 60% by weight, based upon the weight of the water.

The amount of dissolvable solid particulates in the circulating fluid introduced into the wellbore is between from about 0.01 to about 30 weight percent (based on the total weight of the fluid).

The dissolvable solid particulates may be of any shape. For instance, the particulates may be substantially spherical, such as being beaded, or pelleted. Further, the particulates may be non-beaded and non-spherical such as an elongated, tapered, egg, tear-drop or oval shape or mixtures thereof. For instance, the particulates may have a shape that is cubic, bar-shaped (as in a hexahedron with a length greater than its width, and a width greater than its thickness), cylindrical, multi-faceted, irregular, or mixtures thereof. In addition, the particulates may have a surface that is substantially roughened or irregular in nature or a surface that is substantially smooth in nature.

In an embodiment, the circulating fluid may further contain one or more proppants. Such proppants may be left in place after being pumped into a void spaces especially in the near wellbore area. Such proppants would remain in the reservoir after the solid particulates dissolve and thus serve to aid in the connectivity of the established fracture to the wellbore.

Circulating fluid containing proppants protects against the loss of near wellbore connectivity in the event the proppant used in stimulation is displaced deeper into a created fracture and away from the perforations especially in the near wellbore region of the reservoir. This may particularly be an issue in those cases where the operator has to overflush the wellbore in order to remove sand from the casing such that proppant is pushed further into the subterranean formation.

Where the circulating fluid contains dissolvable solid particulates and/or proppant, the fluid is one which is suitable for transporting the particulates into the reservoir and/or subterranean reservoir.

The proppant for use in the mixture may be any proppant suitable for stimulation known in the art and may be deformable or non-deformable at in-situ reservoir conditions. Examples include, but are not limited to, conventional high-density proppants such as quartz, glass, aluminum pellets, silica (sand) (such as Ottawa, Brady or Colorado Sands), synthetic organic particles such as nylon pellets, ceramics (including aluminosilicates), sintered bauxite, and mixtures thereof.

In addition, protective and/or hardening coatings, such as resins to modify or customize the density of a selected base proppant, e.g., resin-coated sand, resin-coated ceramic particles and resin-coated sintered bauxite may be employed. Examples include Suitable proppants further include those set forth in U.S. Patent Publication No. 2007/0209795 and U.S. Patent Publication No. 2007/0209794, herein incorporated by reference.

Further, any of the ultra-lightweight (ULW) proppants may also be used. Such proppants are defined as having a density less than or equal to 2.45 g/cc, typically less than or equal to 2.25, more typically less than or equal to 2.0, even more typically less than or equal to 1.75. Some ULW proppants have a density less than or equal to 1.25 g/cc. Exemplary of such relatively lightweight proppants are ground or crushed walnut shell material that is coated with a resin, porous ceramics, nylon, etc.

In a preferred embodiment, the proppant is a relatively lightweight or substantially neutrally buoyant particulate material or a mixture thereof. Such proppants may be chipped, ground, crushed, or otherwise processed. By “relatively lightweight” it is meant that the proppant has an apparent specific gravity (ASG) at room temperature that is substantially less than a conventional proppant employed in hydraulic fracturing operations, e.g., sand or having an ASG similar to these materials. Especially preferred are those proppants having an ASG less than or equal to 3.25. Even more preferred are ultra-lightweight proppants having an ASG less than or equal to 2.25, more preferably less than or equal to 2.0, even more preferably less than or equal to 1.75, most preferably less than or equal to 1.25 and often less than or equal to 1.05.

By “substantially neutrally buoyant”, it is meant that the proppant has an ASG close to the ASG of an ungelled or weakly gelled carrier fluid (e.g., ungelled or weakly gelled completion brine, other aqueous-based fluid, or other suitable fluid) to allow pumping and satisfactory placement of the proppant using the selected carrier fluid. For example, urethane resin-coated ground walnut hulls having an ASG of from about 1.25 to about 1.35 may be employed as a substantially neutrally buoyant proppant particulate in completion brine having an ASG of about 1.2. As used herein, a “weakly gelled” carrier fluid is a carrier fluid having minimum sufficient polymer, viscosifier or friction reducer to achieve friction reduction when pumped down hole (e.g., when pumped down tubing, work string, casing, coiled tubing, drill pipe, etc.), and/or may be characterized as having a polymer or viscosifier concentration of from greater than about 0 pounds of polymer per thousand gallons of base fluid to about 10 pounds of polymer per thousand gallons of base fluid, and/or as having a viscosity of from about 1 to about 10 centipoises. An ungelled carrier fluid may be characterized as containing about 0 pounds per thousand gallons of polymer per thousand gallons of base fluid. (If the ungelled carrier fluid is slickwater with a friction reducer, which is typically a polyacrylamide, there is technically 1 to as much as 8 pounds per thousand of polymer, but such minute concentrations of polyacrylamide do not impart sufficient viscosity (typically <3 cP) to be of benefit)

Other suitable relatively lightweight proppants are those particulates disclosed in U.S. Pat. Nos. 6,364,018, 6,330,916 and 6,059,034, all of which are herein incorporated by reference. These may be exemplified by ground or crushed shells of nuts (pecan, almond, ivory nut, brazil nut, macadamia nut, etc); ground or crushed seed shells (including fruit pits) of seeds of fruits such as plum, peach, cherry, apricot, etc.; ground or crushed seed shells of other plants such as maize (e.g. corn cobs or corn kernels), etc.; processed wood materials such as those derived from woods such as oak, hickory, walnut, poplar, mahogany, etc. including such woods that have been processed by grinding, chipping, or other form of particalization. Preferred are ground or crushed walnut shell materials coated with a resin to substantially protect and water proof the shell. Such materials may have an ASG of from about 1.25 to about 1.35.

Further, the relatively lightweight particulate for use in the invention may be a selectively configured porous particulate, as set forth, illustrated and defined in U.S. Pat. No. 7,426,961, herein incorporated by reference.

Preferred embodiments of the present disclosure offer advantages over the prior art and are well adapted to carry out one or more of the objects of this disclosure. However, the present disclosure does not require each of the components and acts described above and are in no way limited to the above-described embodiments or methods of operation. Many variations, modifications and/or changes of the disclosure, such as in the components, operation and/or methods of use, are possible, are contemplated by the patent applicant(s), within the scope of the appended claims, and may be made and used by one of ordinary skill in the art without departing from the spirit or teachings of the disclosure and scope of appended claims.

What is claimed is:

1. A method of enhancing the efficiency in the removal of debris from a wellbore penetrating a multi-zoned subterranean reservoir wherein the debris originates, at least in part, from a fluid-impermeable barrier separating perforated zones during a multi-zone fracturing operation, the method comprising:
(a) milling the fluid-impermeable barrier separating the perforated zones;
(b) circulating a fluid through the wellbore and into the separated perforated zones, wherein the fluid comprises water or brine and dissolvable solid particulates;
(c) plugging perforation clusters in the separated perforated zones with the dissolvable solid particulates and preventing the flow of the circulating fluid through the perforation clusters; and
(d) removing debris from the wellbore in the circulating fluid.

2. The method of claim 1, wherein the wellbore is horizontal.

3. The method of claim 1, wherein the dissolvable solid particulates are selected from the group consisting of aliphatic polyesters, benzoic acid, phthalic acid, phthalic anhydride, terephthalic anhydride, terephthalic acid, gilsonite, rock salt, benzoic acid flakes, polylactic acid and mixtures thereof.

4. The method of claim 1, wherein the dissolvable solid particulates are of the formula: 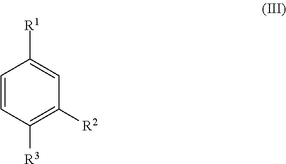
or anhydrides therefore, wherein:
R¹ is —COO—(R⁵O)_{y}—R⁴ or —H;
R² and R³ are selected from the group consisting of —H and —COO—(R⁵O)_{y}—R⁴;
provided both R² or R³ are —COO—(R⁵O)_{y}—R⁴ when R¹ is —H and
further provided only one of R² or R³ is —COO—(R⁵O)_{y}—R⁴ when R¹ is —COO—(R⁵O)_{y}—R⁴;
R⁴ is —H or a C₁-C₆ alkyl group;
R⁵ is a C₁-C₆ alkylene group; and
each y is 0 to 5.

5. The method of claim 4, wherein the dissolvable solid particulates further comprises an aliphatic polyester having the general formula of repeating units: 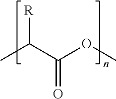
where n is an integer between 75 and 10,000 and R is selected from the group consisting of hydrogen, alkyl, aryl, alkylaryl, acetyl, heteroatoms, and mixtures thereof; and
aliphatic polyester is poly(lactide).

6. The method of claim 4, wherein R¹ is —H.

7. The method of claim 6, wherein y is 0 and R⁴ is —H.

8. The method of claim 4, wherein R¹ is —COO—(R⁵O)_{y}—R⁴ and R² is —H.

9. The method of claim 8, wherein y is 0 and R⁴ is —H.

10. The method of claim 1, wherein the subterranean reservoir is sandstone or carbonate or coal.

11. The method of claim 1, wherein the circulating fluid further comprises a proppant.

12. A method of drilling out a barrier from a wellbore after stimulating multiple zones in a subterranean reservoir penetrated by the wellbore wherein the barrier isolates perforation clusters in a first zone from a second zone, the method comprising:
(a) milling the barrier isolating the first zone and the second zone with a tubing inserted into the well;
(b) circulating fluid comprising dissolvable solid particulates into the wellbore;
(c) blocking, at least partially, the flow of circulating fluid through the perforation clusters into fractures in the first zone and the second zone with the dissolvable solid particulates; and
(d) removing the circulating fluid with debris from the barrier out of the wellbore.

13. The method of claim 12, wherein a barrier separates perforation clusters in the second zone from a third zone and further comprising:
(e) milling the barrier isolating the second zone and the third zone with a tubing inserted into the well;
(f) circulating fluid comprising dissolvable solid particulates into the wellbore;
(g) blocking, at least partially, the flow of circulating fluid through perforation clusters into fractures in the second zone and the third zone with the dissolvable solid particulates; and
(h) removing debris from the wellbore.

14. The method of claim 12, wherein the dissolvable solid particulates in step (b) and step (f) are the same.

15. The method of claim 12, wherein the circulating fluid further comprises proppant.

16. A method of cleaning out a wellbore penetrating a subterranean reservoir wherein different zones of the subterranean reservoir have been successively stimulated by flowing fracturing fluid through perforation clusters and wherein the wellbore is contaminated with debris from a barrier separating two adjacent stimulated zones, the method comprising:
(a) drilling out the barrier isolating the two adjacent zones;
(b) circulating fluid comprising dissolvable solid particulates into the two adjacent zones;
(c) blocking, at least partially, the flow of circulating fluid through the perforation clusters into fractures in the two adjacent zones with the dissolvable solid particulates; and
(d) removing debris from the wellbore.

17. The method of claim 16 further comprising:
(e) drilling out a fluid-impermeable barrier isolating two other adjacent zones having been stimulated by flowing fracturing fluid through perforation clusters;
(f) circulating fluid comprising dissolvable solid particulates into the two other adjacent zones;
(g) blocking, at least partially, the flow of circulating fluid through perforation clusters into fractures in the two other adjacent zones with the dissolvable solid particulates.

18. The method of claim 17, further comprising repeating at least once steps (e), (f) and (g).

19. The method of claim 16, wherein the wellbore is horizontal.

20. The method of claim 16, wherein the dissolvable solid particulates are selected from the group consisting of aliphatic polyesters, benzoic acid, phthalic acid, phthalic anhydride, terephthalic anhydride, terephthalic acid, gilsonite, rock salt, benzoic acid flakes, polylactic acid and mixtures thereof.

21. The method of claim 16, wherein the circulating fluid further comprises a proppant.

22. The method of claim 16, wherein the subterranean reservoir is sandstone or carbonate or coal.
